(19) United States
(12) Patent Application Publication
(10) Pub. No.: US 2017/0335470 A1
(43) Pub. Date: Nov. 23, 2017

(54) LOW POWER OZONE GENERATOR IN MOISTURE RICH CLIMATE FOR THE PRESERVATION OF FRUITS AND VEGETABLES

(71) Applicant: Wakati BVBA, Antwerpen (BE)

(72) Inventors: Michael Gykiere, Antwerpen (BE); Arne Pauwels, Antwerpen (BE)

(73) Assignee: Wakati BVBA, Antwerpen (BE)

(21) Appl. No.: 15/157,852

(22) Filed: May 18, 2016

(51) Int. Cl. C25B 1/13; A23B 7/152; C25B 9/08; C25B 15/02

(52) U.S. Cl. CPC C25B 1/13; C25B 15/02; A23B 7/152; C25B 9/08; A23V 2002/00

(57) ABSTRACT

A device for generating an ozone in a high moisture content environment is provided. The ozone generator features an enclosure with an interior space, an assembly within this interior space, at least one sheet of glass, and a power control board positioned in the housing and which houses the at least one sheet of glass. The assembly features at least one anode and at least one cathode where there is some overlap between the anode and cathode, which are preferably constructed out of aluminum. When in use, the ozone generator creates a plasma discharge which is used to prevent potential corrosive effects that may arise.

### CLAIM OF PRIORITY

This application does not claim priority to any patent or patent application.

### FIELD OF THE EMBODIMENTS

The invention and its embodiments relate to a system and method for preserving food by exposing the food to ozone.

### BACKGROUND OF THE EMBODIMENTS

Almost 90 percent of the global population consumes food products derived from agriculture. Improving the productivity profitability and sustainability of small holder farming is the main pathway out of poverty and the impetus for the innovation and invention described in the present application. The consequences of food waste that is food that spoils before it gets to market or on its way to the marketplace for consumers to purchase has ecological, economics and humanitarian implications. Crops, such as fruits and vegetables that spoil prior to consumption wastes water, leads to soil erosion and useless deforestation. Food waste means that monies spent on hiring workers to harvest, on fertilizers and on-pesticides is also wasted. In addition the social problems caused by food waste ultimately leads to hunger which can lead to whole regions and continents being malnourished and cognitive impairment which in many cases leads to social unrest. The need to keep crops and already produces food fresh for human consumption, post-harvest is the problem this invention solves.

The average smallholder farmer face large losses of food due to spoilage at stage getting numbers. The FAO states that almost 45 percent of fruits and vegetables in developing countries never reach the consumers market tables or mouths. The smallholder farmer and their direct reseller, the market vendor lack the adequate protection for their produce from the harsh climate pests and diseases present in high moisture or humid climates. The present invention, marketed as a Wakati device solves the issue facing these farmers and vendors.

The invention comprises wireless climate chamber device for storing fruits and vegetables such that any vegetables or fruits inside the device when stored at an optimal temperature and amount of time stay fresh longer thereby increasing profitability and portability in the supply chain. The invention may be used on the crop field, via transport from field to market vendor, via transport from market vendors to consumer home or even by the consumer at their home. Each step of the supply chain is assisted and each benefits from the problems the invention solves. The present invention, providers a chamber where the climate in which fruit and vegetables are stored is altered in order to increase shelf life and reduce post-harvest loss. The device requires a fraction of the energy and materials necessary for traditional cooling systems such as the portable refrigerator and freezer and as found in the prior art.

For example the present invention is a marked improvement over the use of evaporation coolers. Such coolers use 350 to 700 liters of water for 100 kg of crops while the present invention uses 2 liters for 100 kg of crops. Such large amounts of water are unobtainable in large regions of Africa where water is scarce.

Examples of related art are as follows:

U.S. Pat. No. 9,039,985 pertains to an ozone generator cells that include two thermally conductive plates that maintain contact between various layers of the cells in the absence of a bonding agent. The cells lack aluminum-containing materials in the discharge region of the cell.

U.S. Pat. No. 7,401,469 pertains to a system and method for preserving food. Embodiments of the system include a food compartment to store food and a user interface configured to receive user input relating to the preservation of the food stored. The system also includes a humidity sensor configured to sense a humidity level, an ozone generator configured to generate ozone gas, an ozone sensor configured to sense an ozone level and a gas sensor configured to sense a level of residual gases inside the food compartment. The system further includes a controller, responsive to the user interface, the humidity sensor, the ozone sensor and the gas sensor. In one embodiment, the controller preserves the food stored in the food compartment as a function of the user input, the humidity level, the ozone level, the residual gas level and as a function of a type of the food stored in the food compartment.

U.S. Pat. No. 5,762,886 pertains to an ozone generator for deodorizing and sterilizing without doing harm to a human body, and being applied to general home appliances, includes a discharger for discharging using high voltage generated from a high-voltage generating portion and an ozone generator for generating ozone by secondary-discharging with a medium of metal inside of the discharger. Thus, ozone can be generated in a place of high temperature, humidity and much dust and at a lower cost, and since a glass tube, a glass bar and a ceramic stick are employed, product cost is reduced.

U.S. Pat. No. 4,988,484 pertains to an ozone generator for producing ozone at pressures of up to 10,000 psi from oxygen or oxygen containing gas, which contains two electrodes for forming a corona discharge through the input gas, the first electrode being cooled by a first cooling fluid and the second electrode being cooled by a second cooling fluid, which further contains flexible barrier means for equalizing the pressure between the cooling fluids and the input gas.

U.S. Pat. No. 5,503,808 pertains to a portable compact ozone generator for producing a consistent source of ozone portably that eliminates nitrous oxides and nitric acid. The device includes a small air compressor that provides compressed ambient air to a pair of molecular sieves that eliminate humidity and concentrates oxygen to provide a source of dry oxygen to the ozone generator.

U.S. Pat. No. 4,882,129 pertains to an ozone generator cell of a novel design includes a thin ceramic sheet sandwiched between a perforated metallic sheet serving as discharge electrode and a water-cooled aluminum base. Dry air or oxygen is passed over the electrode surface and a high-voltage, high-frequency electric field is applied between the electrode and the base for a corona discharge.

U.S. Pat. No. 7,687,040 pertains to a portable ozone generator for use in small, confined, uninhabited spaces, such as refrigerators. The generator has a clam shell top and bottom. The bottom is of unitary construction and houses batteries. The top house electrical components, including circuitry for time generation of ozone.

U.S. Pat. No. 5,607,562 pertains to an electrolytic ozone generator comprising anode chamber and cathode chamber partitioned by solid electrolyte, in which deionized water is electrolyzed in the cathode chamber while feeding air or oxygen-rich air to the cathode chamber through, for example, air holes. The air fed suppresses evolution of hydrogen gas thereby affording a saving of energy and eliminating the need a separate cooling mechanism. Furthermore, the air also decomposes ozone having entered the catholyte.

U.S. Pat. No. 5,252,300 pertains to a method and apparatus for reducing corrosion in a water recirculation system. The method involves ozonating the water and adjusting the level of the calcium bicarbonate in the ozonated water to a predetermined level. The predetermined level is a level above that which would cause a scaling water but will not cause such scaling in the ozone solution.

U.S. Pat. No. 4,504,446 pertains to an air-cooled ozone generator of tubular type which has a tubular outer electrode, a tubular dielectric, for instance of glass, arranged inside the outer electrode, and an inner electrode in the form of a metal coating on the inner side of the dielectric. The outer electrode and the dielectric are spaced apart and the resulting intermediate annular gap forms a discharge space in which oxygen is converted to ozone. The ozone generator is operated by means of a low-voltage, high-frequency AC source connected to the electrodes. The outer electrode has cooling flanges, and inside the inner electrode there is provided at least one heat dissipating metal body insertable in the inner electrode and expandable to abutment against the inner electrode. Preferably, the metal body also serves as an electric connection for connecting the inner electrode to the voltage source. The metal body preferably consists of a sheet formed into a cylinder with two inwardly directed flanges.

U.S. Pat. No. 7,425,301 pertains to an ozone sanitation device and system and a method of using the same to sanitize various objects in various environments. The present invention is particularly adapted to be used to sanitize food products, such as fruit and vegetable products as well as others at the site of the marketing and selling of such products. The ozone sanitation device functions to combat harmful pathogens by reduce microbial growth and bacteria existing on the treated object. The device comprises an ozone generator that produces ozone gas that mixes with temperature controlled water to create an ozonated water solution to be applied to an object for treatment. Moreover, the present invention features several methods of using the ozone sanitation device to treat various objects, as well as a method for restoring water to dehydrated objects, such as fruits and vegetables. The method provides a continuous process and comprises using a tepid wash solution cycle and a chilled wash solution cycle of water and the application of ozone and oxygen.

U.S. Pat. No. 8,377,385 pertains to a dielectric assembly for generating ozone includes a positive electrode, a negative electrode in operational proximity to the positive electrode, a dielectric in operational proximity to the positive and negative electrodes for generating the ozone, and a knob adapted to extend outside of a housing into which the dielectric assembly is to be placed. A system is also provided for sanitizing and deodorizing water, food, surfaces and air including a microbiological reduction filter device having an input connected to a water supply, a venturi injector disposed within a housing and connected to an output of the microbiological reduction filter device which generates ozone and mixes the generated ozone with the water, and an electrode assembly comprising a plurality of electrodes, a dielectric for generating the ozone, and a knob extending outside of the housing. The dielectric in a first embodiment and the entire dielectric assembly in a second embodiment can be removed from the housing and replaced in its entirety by the knob.

U.S. Pat. No. 5,824,274 pertains to a water purifier and surface sanitizer uses an ozone generator but requires no air dryer, is adapted for simple maintenance and for use in remote areas from low-voltage DC. The sanitizer has a housing with a high-voltage supply device such as a pulse coil, coupled directly to a tubular inner electrode. A dielectric tube of borosilicate glass (e.g. PYREX) is shaped like a test tube with one open end, and slides over the inner electrode with a push fit. The dielectric tube is easy to clean since it is can be nulled off the inner electrode, cleaned with acid/neutralizer or detergent to remove built-up surface-contaminants, and replaced; this avoids any need for an air dryer. An outer electrode includes an air space (corona space) and gaps for ventilation. Air passes over the dielectric, becoming ozonated by the high voltage, and is drawn into a water stream by a venturi. The water may also pass through a particle filter. The water flow is controlled by an fully-on or fully-off faucet.

U.S. Pat. No. 4,970,056 pertains to an ozone generating cell which utilizes a quartz dielectric for providing high purity ozone. The quarts dielectric is cemented to one of the electrodes of the cell, and is then ground to a desired dimension.

U.S. Pat. No. 5,770,168 pertains to an ozone producing machine that produces ozone by ionizing oxygen in the input gas with a high voltage arc. The present invention includes an electronic circuit that is used to drive a high frequency self oscillating push-pull ozone generating cell. The ozone cell has a self resonant frequency that is determined by the construction of the ozone cell and by the characteristics of the gas (air or oxygen) being put through the cell. Ozone production by the cell is maximized when the cell is preferably driven at ⅔ times the resonant frequency. The present invention detects the resonant frequency of the cell and drives the cell at ⅔ times that resonant frequency. Further, the invention detects any changes in the resonant frequency of the cell and adjusts the drive to the cell to compensate for those changes, thus driving the cell at the optimum frequency for maximal ozone production.

U.S. Pat. No. 7,874,245 pertains to a container for perishable food items, such as fruits and vegetables is provided with a device for producing a substance for killing the fungus or bacteria said substance adhering to the surface of the food item. This substance produced by a device for generating ozone or an oxygen atom and is directly provided in or attached to the food container. A retractable hood can be utilized to prevent the substance from entering the atmosphere of a room prior to the completion of a treatment. A fan is provided for assisting in the introduction as well as the elimination of the substance to and from the interior of the container.

United States Patent Publication No.: 2015/0210545 pertains to an ozone generator includes one or more electrode pairs each containing two electrodes arranged at a distance of a predetermined gap length and a power source for applying an alternating-current voltage between the two electrodes. In the ozone generator, ozone is produced when a source gas flows at least between the two electrodes and a discharge is generated between the two electrodes. The ozone generator has a discharge space formed between the two electrodes, and the ozone generator satisfies the condition of 0.5<V/f/L wherein V (m/s) represents a flow velocity of the source gas flowing through the discharge space, f (Hz) represents a frequency of the alternating-current voltage, and L (m) represents a length of the discharge space in the main flow direction of the source gas.

International Patent Document No.: WO 2013126024 pertains to an application system and implementation method of humidity, ozone, various chemicals and/or different physical applications together on fresh fruit and vegetables.

International Patent Document No.: WO 2012064454 pertains to corrosion Resistant Ozone Generators, including ozone generating chips, for various purposes including spas, pools and jetted tubs as well as methods for making and using such Corrosion Resistant Ozone Generators.

Chinese Patent Document No.: CN 201240843 pertains to a small high-efficiency tubular centralized ozonizer, comprising an outer electrode, a medium layer, an inner electrode and an inner electrode holder; the outer electrode is a metal circular tube, the medium layer is closely attached to the inner tube wall of an out-gassing section of the outer electrode, the inner electrode is arranged in the middle of the outer electrode closely attached with the medium layer; the inner electrode is a circular metal plate, the periphery of which is provided with a radial thin slice; the outer edge of the radial thin slice of the inner electrode is closely attached to the medium layer, a central round orifice is arranged in the center of the inner electrode; the inner electrode holder penetrates through the central round orifice of the inner electrode and is fixed on the outer electrode, a gas intaking end of the outer electrode is connected with a gas intaking pipe, and the connecting position is provided with a first fan which is fixed on the gas intaking pipe. The ozonizer has low power consumption, the cooling performance is good, the service life is long, the working performance is stable, and the electromagnetic compatibility is good.

Chinese Patent Document No.: CN 2712892 pertains to a temperature sensor for a radiant heater has a first tubular expansion element which is connected to its housing and contains a second rod-like expansion element, the two expansion elements having different coefficients of thermal expansion. The temperature sensor has two switching springs for different switching points. In order to adjust a second switching spring, which is fastened to a second switching spring base, the second switching spring base can be moved in the longitudinal direction of the rod and is then permanently fixed by bending or welding.

International Patent Document No.: WO 2006044659 pertains to a portable ozone generator for use in small, confined, uninhabited spaces, such as refrigerators. The generator has a clam shell top and bottom. The bottom is of unitary construction and houses batteries. The top house electrical components, including circuitry for time generation of ozone.

Chinese Patent Document No.: CN 104197458 pertains to a fruit and vegetable humidification device based on atomization energy consumption and the water temperature and a humidification method thereof. The fruit and vegetable humidification device comprises a water storage tank, an ultrasonic atomization device arranged in the water storage tank and a water mist conveying device, wherein the water mist conveying device is arranged on the water storage tank and communicated with the water storage tank. The fruit and vegetable humidification device further comprises a control module, a signal acquisition module and an energy consumption meter, wherein the signal acquisition module and the energy consumption meter are respectively connected with the control module, and the signal acquisition module comprises a temperature sensor, a relative humidity sensor and a water temperature sensor which are respectively connected with the control module. The temperature sensor and the relative humidity sensor are arranged in a fruit and vegetable environment, and the water temperature sensor is arranged in the water storage tank. The ultrasonic atomization device is connected with the control module, and the working state of the ultrasonic atomization device is controlled by the control module. The energy consumption meter is connected with the ultrasonic atomization device and used for detecting atomization energy consumption of the ultrasonic atomization device. The fruit and vegetable humidification device has the advantages of high humidification control accuracy and good humidification effect.

Chinese Patent Document No.: CN 101228895 pertains to a fresh-keeping method for fruits and vegetables, which comprises the following steps that: selecting fruits and vegetables and encasing in boxes; prestorage: disinfecting the prestorage room and placing in fruit boxes full of fruits and vegetables; when the prestorage begins, turning on an ultrasonic humidifiens and an ozone generator to control the relative humidity of the prestorage room less than 80 percent, the ozone concentration of the prestorage room between 5 and 20 mg/m<3>; storing in the storeroom: disinfecting the storeroom and placing in the prestored fruit boxes and at the same time turning on the ultrasonic humidifiens and the ozone generator to control the relative humidity of the storeroom between 80 percent and 98 percent, the ozone concentration of the storeroom between 5 and 20 mg/m<3>. The invention combines ultrasonic humidifying with ozone sterilization to carry out humidification and sterilization and antisepsis to the fruits and vegetables, etc., stored in the storeroom; moreover, synchronically preventing fresh fruits and vegetables from wilting and decay, which greatly reduces the decay rate of raw material and keeps the raw material in good state, thus acquiring a longer preservation period.

Chinese Patent Document No.: CN 202406944 pertains to a novel electronic fruit and vegetable refreshment machine which adopts an operation mode of a manual control button. A manual control plate, a booster transformer and an ozone generator are connected by a power line to form an ozone supplying system circuit; the manual control plate, the booster transformer and a negative ion generator are connected by a power line to form an ion supplying system circuit; the ozone supplying system circuit and the ion supplying system circuit are connected in parallel and are controlled by the manual control button to complete the key pressing operation; a screen display operation interface is connected by an electric wire hidden in an inner wall; meanwhile, different refreshment modes can be set, and the released ozone passes through an ozone generation hole, the generated negative ion is released via the ozone generation hole and is released to an object storage box via a clapboard gap on a clapboard.

Various devices are known in the art. However, their structure and means of operation are substantially different from the present invention. At least one embodiment of this invention is presented in the drawings below, and will be described in more detail herein.

### SUMMARY OF THE EMBODIMENTS

The present invention provides for a device for generating a ozone in a high moisture content environment, comprising: an enclosure with an interior space, an assembly within the interior space comprising: a housing; at least one anode electrode and at least one cathode electrode; wherein the anode electrode and the at least one cathode electrode overlaps one another; and wherein the at least one electrodes are comprised of aluminum; and wherein said at least one electrode generates a plasma discharge to prevent corrosive effects of the at least one cathode electrode and the at least one anode electrode; at least one sheet of glass positioned between the overlapping at least one electrodes, a power control board positioned in the housing and which houses the at least one sheet of glass; said power control board adapted and configured to discharge corona. In some embodiments, the overlap is at least 2 mm. In other embodiments, the glass is comprised of borosilicate. Preferably, the glass is at least 1.2 millimeters in thickness and has dielectric constant of at least 4.6. In a preferred embodiment, the ads has a dielectric strength of 3 kV/mm. In other preferred embodiments, the ozone generates between 0.5 ppm and 2 ppm for a period of time between 3 and 7 hours per day. In various embodiments the electrodes are composed of a plurality of shapes, and will feature sharp edges and will be angular. Preferably, the generator creates an electrical current with a voltage measuring at least one kilovolt (kV).

It is an object of the present invention to provide a means for generating ozone.

It is an object of the present invention to provide a means for preventing food spoliation.

It is an object of the present invention to provide a machine that can reduce the amount of ethylene in a given area.

### BRIEF DESCRIPTION OF THE DRAWINGS

FIG. 1 shows an embodiment of the packaging of the tent of the present invention.

FIG. 2 shows an embodiment of the enclosure of the present invention.

FIG. 3 shows an embodiment of the tent poles of the present invention.

FIG. 4 shows an embodiment of the tent of the present invention.

FIG. 5 shows an alternative embodiment of the tent of the present invention.

FIG. 6 shows an embodiment of the climate unit of the present invention.

FIG. 7 shows an embodiment of the tent present invention, filled with a climate unit and some crops.

FIG. 8 shows one location where the solar panel of the present invention may be installed.

FIG. 9 shows an embodiment of the climate unit of the present invention.

FIG. 10 shows the internals of the embodiment shown in FIG. 9.

FIG. 11 shows an embodiment of the corona discharger of the present invention.

FIG. 12 shows an alternative embodiment of the corona discharger of the present invention.

FIG. 13 shows the mechanism for ozone breaking down ethylene.

FIG. 14 shows another alternative embodiment of the present invention.

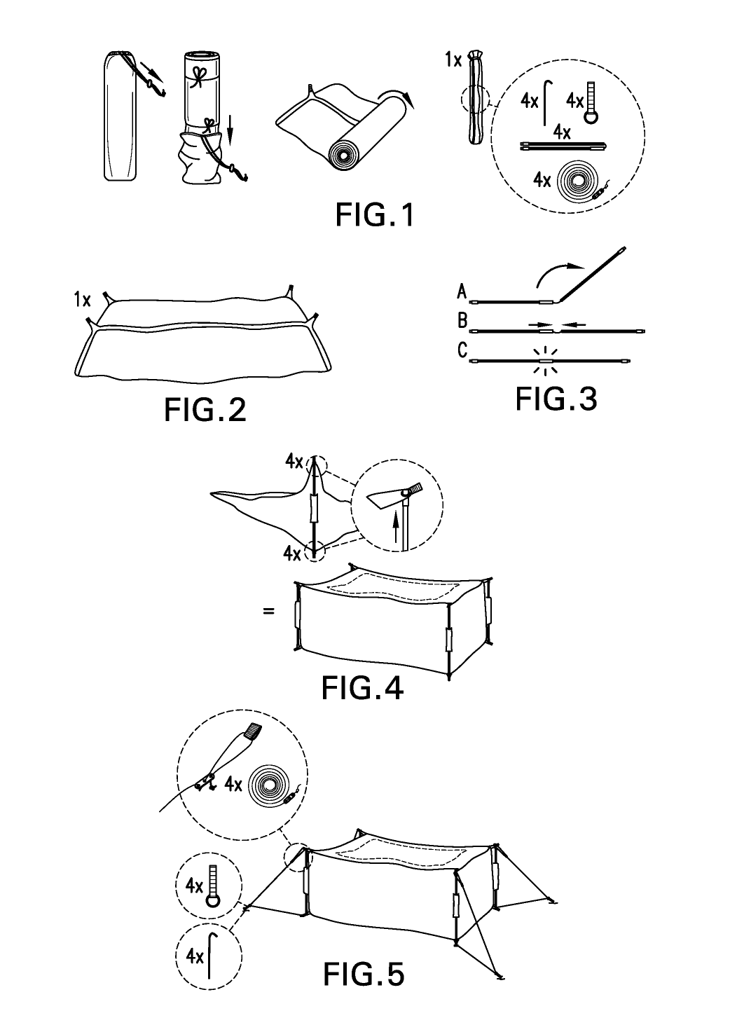

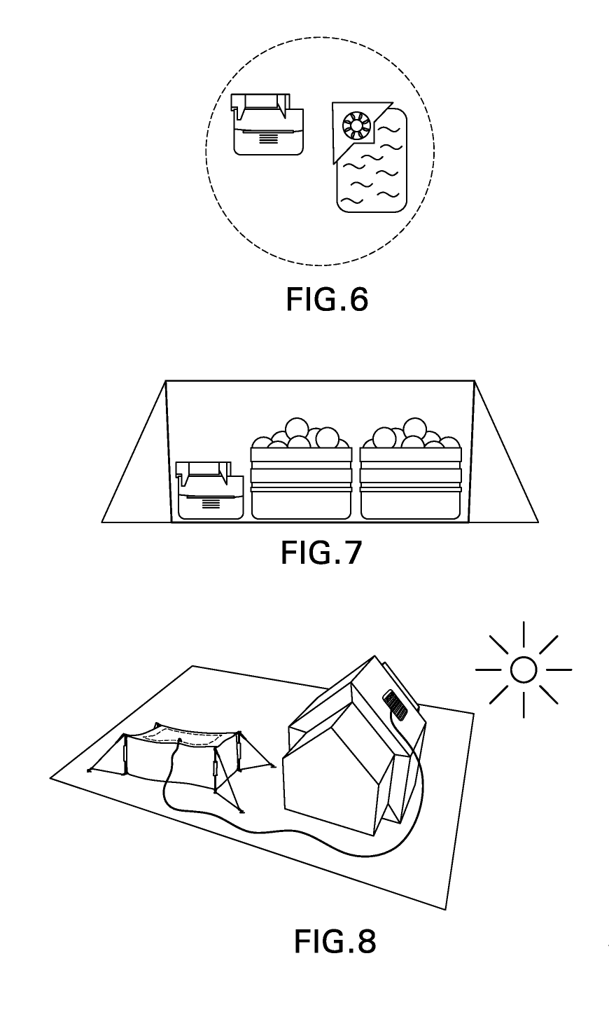

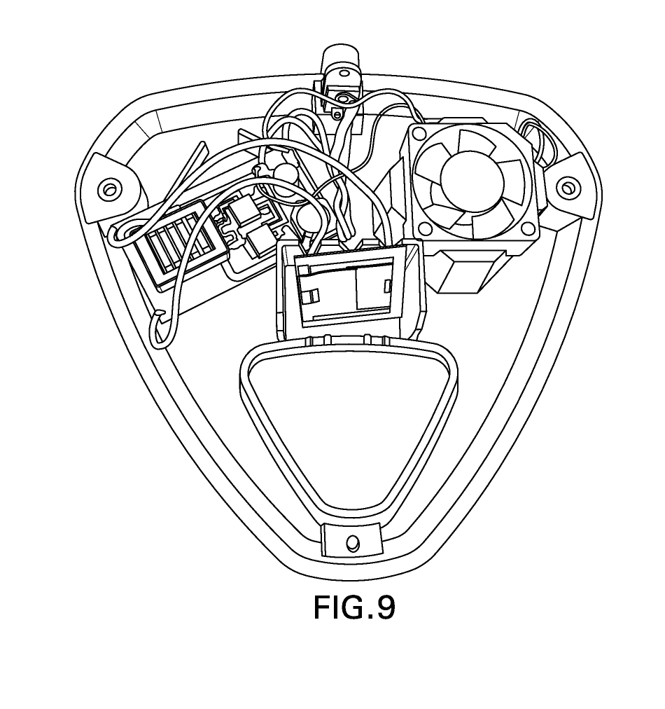

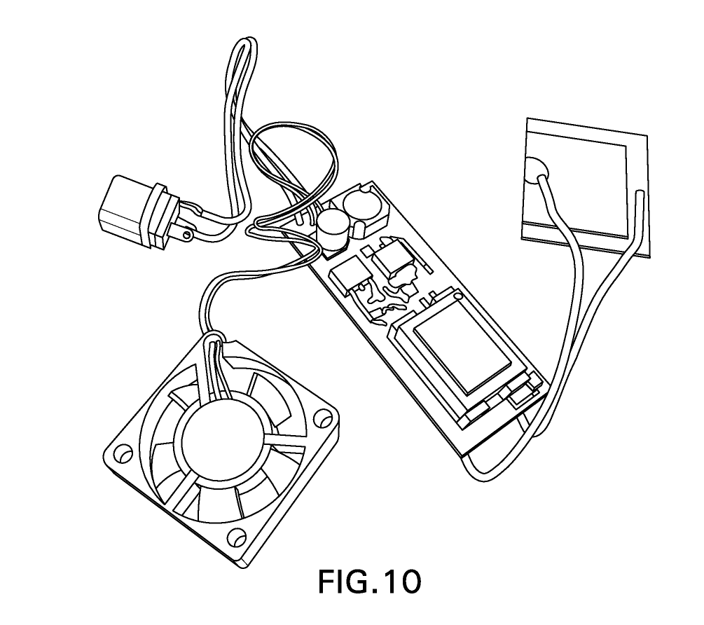

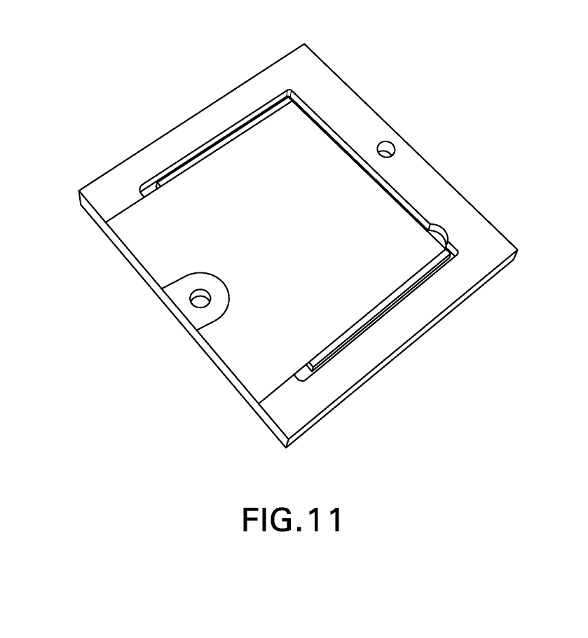

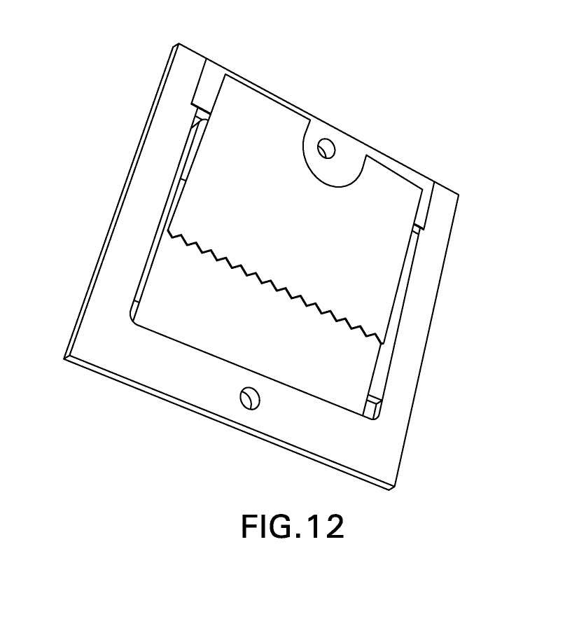

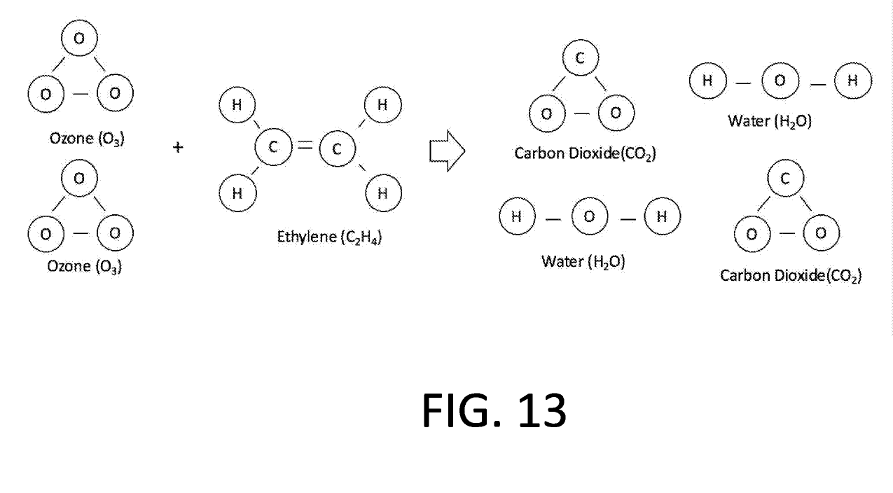

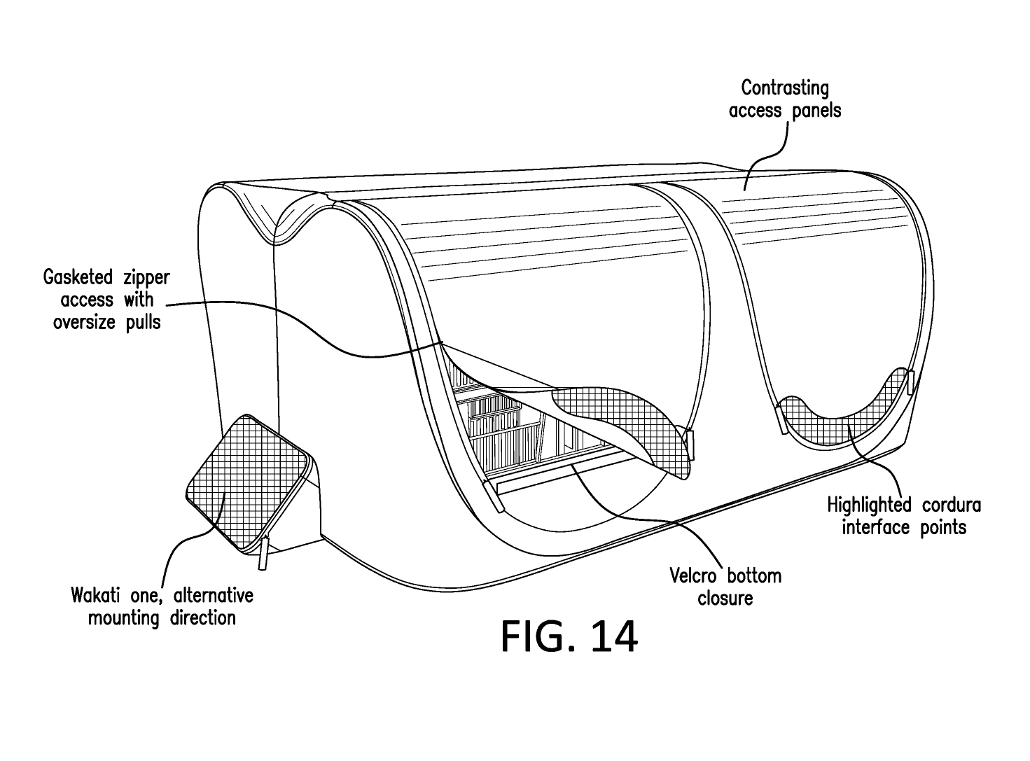

### DESCRIPTION OF THE PREFERRED EMBODIMENTS

The preferred embodiments of the present invention will now be described with reference to the drawings. Identical elements in the various figures are identified with the same reference numerals.

Reference will now be made in detail to each embodiment of the present invention. Such embodiments are provided by way of explanation of the present invention, which is not intended to be limited thereto. In fact, those of ordinary skill in the art may appreciate upon reading the present specification and viewing the present drawings that various modifications and variations can be made thereto.

The device creates a closed environment that is sterile and by adding an anti-fungal product the fruits and vegetables protect the crops from water loss, bruises and fungi. The device only uses two liters of water a week and is self-sufficient by utilizing a 3 watt solar panel. In another embodiment the device may be larger or small, use more or less water and be powered by a larger or smaller wattage solar panel depending on the needs of the farmer, market vendor or consumer.

The unique cell structure of fruits and vegetable allows such crops to withstand high temperatures as long as they have a high turgor presage provided by the continuous flow of sap from the plant to keep the crop dehydrated. When a crop is harvested and removed from its root the link to their sap is lost and the dehydration clock begins to tick. A vegetable or fruit cell that is dehydrated ruptures easily and quickly causing vacuole fluid, an acid to form. This acid liquid contains enzymes which causes irreversible cell damage and decomposes the crop from the inside out. As such the dehydrated fruit or vegetable bruises easily. Bruising causes ethylene gas to be produced which attracts insects and fungi. If the fruit or vegetable is stored in an environment that mimics that can preserve the stability of their firm cell structure, the crops remain fresh and unbruised for a longer period of time. Buying time is what the present invention does. The present invention allows the crops cell structure to remain intact and prevents dehydration by creating a saturated humidity inside the device so that the crop doesn't lose water which is the primary effect of harvested dehydrated crop. The present invention not only protects the crops cells structure by creating high humidity but also destroys fungi and prevents further contamination of rotting crops by creating ozone. Ozone is created by a corona discharge, which is generated by multiplying the voltage from the solar panel so that no additional inputs it fungicides are needed.

Ozone also for the elimination of ethylene production which is the ripening hormone of fruits and vegetables. Without ethylene and in the presence of high temperatures, crops do not bruise easily and rotting is slowed down. The ozone created by the present invention oxidizes ethylene into carbon dioxide and water, which prevents the rotting process. Any ozone produced by the present invention is below any dangerous level to human beings or animals.

The present invention creates an environment where the hardness and weight loss of the crop is retained. Hardness is a good indicator for the transport suitability a crop may have while a crops weight loss is directly linked with how sellable a crop is. The less weight a particular vegetable or fruit undergoes or the more hard a fruit or vegetable is directly indicative to its freshness, ripeness and consumer consumptions. Depending on the particular fruit or vegetable, the present inventions allows for the weight loss of the fruit or vegetable to be dramatically decreased.

The present invention operates by creating air ions. Air ions are short lived, lasting only minutes before they lose their charge. Their life-time is reduced by contacting walls or surfaces, or by interactions with pollutants or humidity in the air. Negative air ions (NAI) reduce airborne mold and bacterial contaminants. The growth of cultured bacteria is retarded and the viability of bacteria and fungal spores in aerosols is reduced by exposure to NAI in concentrations ranging from 5×10⁴ to 5×10⁶ ions/cm³. A combination of ozone (O₃) with NAI is reported to be more effective than either of them alone, in suppressing microbial growth and decay of fresh produce. When cultures of Erwinia caratovora were exposed to 10⁶ NAI/cm³ and/or 50 ppb O₃ at 10° C. for 6 hours, viability of O₃ treated bacteria was 70%, whereas viability of those treated with O₃ and NAI was only 4%. The synergistic effect of NAI with O₃ could explain the variable effectiveness of O₃ in reducing decay of stored produce. In two separate studies, the lesion growth rates of Botrytis cinerea and Sclerotinia sclerotiorum on fresh carrots was reduced by 12% and 16%, respectively, when held in 1 ppm O₃ without NAI. However, in a similar trial where carrots were held in 0.1-0.5 ppm O₃ in combination with 2×10⁴ to 7×10⁴ NAI/cm³, growth rates of B. cinerea and S. sclerotiorum were reduced by 69% and 57%, respectively. The apparent synergism of NAI with O₃ could provide an effective method to reduce postharvest decay of fresh produce.

The present invention allows for the addition of various natural product such as essential oils or the odorless hydrogen peroxide to be added to the device in order to eliminate/reduce the amount of fungicides the crop may grow. In a preferred embodiment of the present invention 5 hours of sunlight a day is needed to provide the energy to run the device. The present invention is lightweight and weighs about 5 kg or roughly 11 pounds. The present invention is collapsible and requires minimal set up and installation.

In a preferred embodiment, the present invention is capable of optimizing the properties of the inner chamber for various crops. This embodiment allows a user to adjust the humidity, ozone level, and ionization level of the present invention. These levels can be correlated to optimally store a particular crop or crops. In various embodiments, this functionality is achieved by a fan to control the humidity. Further, preferred embodiments will provide for the ozone generator to be at full power, half power, or simply be off. Additionally, other embodiments will have the ability to selectively turn off the ionization caused by the present invention.

In another preferred embodiment, the present invention is capable of entering a sterilization mode where the ozone generator is left of full power for a predetermined period of time. This setting is intended to be used when the present invention is not filled with produce. Further, some embodiments of the present invention are capable of merely generating ionizing air, so that a walk-in embodiment of the present invention may be used. It should be noted that in various embodiments, the present invention may take a wide variety of sizes.

While this disclosure refers to exemplary embodiments, it will be understood by those skilled in the art that various changes may be made and equivalents may be substituted for elements thereof without departing from the scope of the disclosure. In addition, many modifications will be appreciated by those skilled in the art to adapt a particular instrument, situation or material to the teachings of the disclosure without departing from the spirit thereof. Therefore, it is intended that the disclosure not be limited to the particular embodiments disclosed.

When introducing elements of the present disclosure or the embodiment(s) thereof, the articles “a,” “an,” and “the” are intended to mean that there are one or more of the elements. Similarly, the adjective “another,” when used to introduce an element, is intended to mean one or more elements. The terms “including” and “having” are intended to be inclusive such that there may be additional elements other than the listed elements.

What is claimed is:

1. A device for generating a ozone in a high moisture environment, comprising:
an enclosure with an interior space;
an assembly within the interior space, comprising:
a housing,
at least one anode electrode, and
at least one cathode electrode,
wherein the anode electrode and the at least one cathode electrode overlaps one another,
wherein the at least one anode electrode and the at least one cathode electrode are comprised of aluminum, and
wherein said at least one electrode generates a plasma discharge to prevent corrosive effects of the at least one cathode electrode and the at least one anode electrode;
at least one sheet of glass positioned between an overlap of the at least one anode electrode and the at least one cathode electrode,
a power control board positioned in the housing and which houses the at least one sheet of glass; said power control board adapted and configured to discharge corona.

2. The device of claim 1, wherein the overlap is at least 2 mm.

3. The device of claim 2, wherein the overlap ranges between 0.1 mm and 2 mm.

4. The device of claim 1, wherein the glass is comprised of borosilicate.

5. The device of claim 1, wherein the glass is at least 1.2 millimeters in thickness.

6. The device of claim 5, wherein the glass has a thickness in the range of 0.8 mm to 1.4 mm.

7. The device of claim 1, wherein the glass has a dielectric constant of at least 4.6.

8. The device of claim 5, wherein the glass has a dielectric constant ranging between 3.4 and 4.6.

9. The device of claim 1, wherein the glass has a dielectric strength of 3 kV/mm.

10. The device of claim 1, wherein the glass has a dielectric strength in the range of 3.7 Kv/mm to 50 kV/mm.

11. The device of claim 1, wherein ozone is generated between 0.5 ppm and 2 ppm for a period of time between 3 and 7 hours per day.

12. The device of claim 1, wherein ozone is generated between 0.5 ppm and 2 ppm for a period of time of at least three hours per day.

13. The device of claim 1, wherein the amount of ethylene in the enclosure is reduced by ozone.

14. The device of claim 1, wherein the electrodes are composed of a plurality of shapes.

15. The device of claim 1 wherein the electrodes comprise sharp edges and are angular.

16. The device of claim 1 wherein the generator creates an electrical current with a voltage measuring at least one kiloVolt.

17. The device of claim 1, wherein the generator creates an electrical current with a voltage measuring at least 470 volts at a frequency of 80 kilohertz.

18. The device of claim 1, wherein the device produces both ozone and air ions.

19. The device of claim 1, wherein the aluminum is placed on the glass by vapor deposition after a copper ground layer is deposited via chemical vapor deposition.
